(19) United States
(12) Patent Application Publication
(10) Pub. No.: US 2008/0079698 A1
(43) Pub. Date: Apr. 3, 2008

(54) Item navigation and selection methods

(75) Inventors: Hsi-Kun Chen, Taoyuan (TW); Yih-Feng Kao, Taoyuan (TW)

Correspondence Address: BIRCH STEWART KOLASCH & BIRCH, PO BOX 747, FALLS CHURCH, VA, 22040-0747, US

(73) Assignee: HIGH TECH COMPUTER, CORP.

(21) Appl. No.: 11/882,946

(22) Filed: Aug. 7, 2007

(30) Foreign Application Priority Data
Sep. 28, 2006 (TW) 95135948

(51) Int. Cl. G06F 3/041

(52) U.S. Cl. 345/173

(57) ABSTRACT

Item navigation and selection methods are provided. Scrolling navigation and item selection can be initiated on a list of items by contact with a specific zone on a touch-sensitive mechanism. Contact movement along the touch-sensitive mechanism allows scrolling and selection of specific items.

### BACKGROUND OF THE INVENTION

1. Field of the Invention

The disclosure relates generally to item navigation and selection methods, and, more particularly to item navigation and selection methods that initiate navigation and item selection at any position in a list using a touch-sensitive mechanism.

2. Description of the Related Art

When portable devices, particularly handheld devices such as PDAs, smart phones, and mobile phones first emerged on the market, most units were simple to operate, had relatively few controls, and were used primarily for making phone calls.

As handheld devices have become more and more advanced and multifunctional, with email software, advanced-feature address books, and various other applications and programs being added, handheld users more increasingly depend on such applications for professional and personal use.

Accordingly, large amounts of data are normally entered into such device databases, requiring scrolling through long lists of items to retrieve important data. In most long content lists, cursors are located at the top of a page by default, with scrolling beginning at that location. As a result, repetitive and discontinuous actions are required when scrolling, a time-consuming and inconvenient operation.

### BRIEF SUMMARY OF THE INVENTION

Item navigation and selection methods are provided.

In an embodiment of an item navigation and selection method, contact on a touch-sensitive mechanism is detected. In response to the contact, a first group is determined from a sequence of groups according to a contact position on the touch-sensitive mechanism, and a first item is selected and set as a selected item from a plurality of items in the first group. It is determined whether the contact on the touch-sensitive mechanism remains. If the contact remains and moves toward a direction, a second item is re-selected and set as the selected item from the items according to the direction.

In an embodiment of an item navigation and selection method, a contact on a touch-sensitive mechanism is detected. A specific position in a sequence of a plurality of items is determined according to a contact position on the touch-sensitive mechanism. It is determined whether the contact on the touch-sensitive mechanism remains. If the contact remains and moves toward a direction, the items are navigated from the specific position in the sequence according to the direction.

In an embodiment of an item navigation and selection method, a contact on a touch-sensitive mechanism is detected. In response to the contact, a specific position in a sequence of items is determined. The sequence comprises a plurality of item groups, each comprising at least one item. It is determined whether the contact on the touch-sensitive mechanism remains. If the contact remains and moves toward a direction, the items are navigated from the specific position according to the direction. It is determined whether the movement of the contact conforms to a condition. If so, the item groups are navigated according to the direction.

Item navigation and selection methods may take the form of program code embodied in a tangible media. When the program code is loaded into and executed by a machine, the device becomes an apparatus for practicing the disclosed method.

### BRIEF DESCRIPTION OF THE DRAWINGS

The invention will become more fully understood by referring to the following detailed description with reference to the accompanying drawings, wherein:

FIGS. 1A and 1B show an embodiment of a portable devoice with a touch-sensitive mechanism;

FIG. 2 is a flowchart of an embodiment of an item navigation and selection method;

FIGS. 3A and 3B are schematic diagrams illustrating an example of an embodiment of item navigation and selection;

FIGS. 4A and 4B are schematic diagrams illustrating an example of an embodiment of item navigation and selection;

FIG. 5 is a flowchart of another embodiment of an item navigation and selection method; and

FIG. 6 is a flowchart of still another embodiment of an item navigation and selection method.

### DETAILED DESCRIPTION OF THE INVENTION

Item navigation and selection methods are provided.

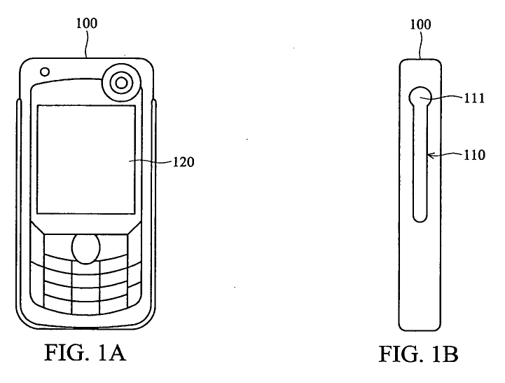

FIGS. 1A and 1B show an embodiment of a portable devoice with a touch-sensitive mechanism.

The portable device 100 may be a handheld device such as PDA, smart phone, global positioning device, or mobile phone. The portable device 100 comprises a display unit 120, and a touch-sensitive mechanism 110 set on the side thereof. The touch-sensitive mechanism 110 has an elongated touch-sensitive surface, and a specific portion 111 is located in the end region of the elongated touch-sensitive surface. It is noted that, in this embodiment, the specific portion of the touch-sensitive mechanism 110 is at the top of the elongated touch-sensitive surface. In some embodiments, however, the specific portion of the touch-sensitive mechanism 110 may be at the bottom of the elongated touch-sensitive surface, or two ends of the elongated touch-sensitive surface may have respective specific portions. Additionally, while touch-sensitive mechanism 110 has a one-dimensional sensor, the disclosure is not limited thereto, and the touch-sensitive mechanism may have a multi-dimensional sensor.

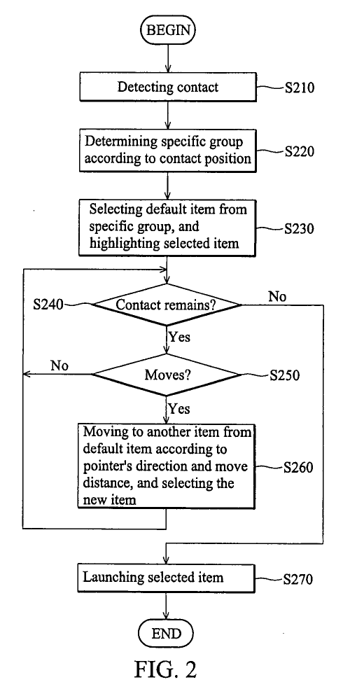

FIG. 2 is a flowchart of an embodiment of an item navigation and selection method. In this embodiment, a specific item group is first determined, and item navigation begins from the item group.

In step S210, contact of a pointer such as a finger or stylus on the touch-sensitive mechanism is detected. It is understood that the pointer can make contact with the touch-sensitive mechanism at a specific portion, any position, or any position for a predetermined interval to trigger detection of contact. In step S220, in response to the contact, a specific group in a sequence of item groups is determined according to a contact position of the contact on the touch-sensitive mechanism. Each item group comprises at least one item. The item may be any kind of data, such as email message, address book entry, or others. The items may be grouped according to letter, numeral, or date. Since the specific group is determined according to the contact position on the touch-sensitive mechanism, the touch-sensitive mechanism is defined into a plurality of regions, each corresponding to one item group. When the pointer makes contact with one specific region, an item group corresponding to the specific region is determined.

In step S230, a default item in the items of the specific group is selected, and the selected item is highlighted in the display unit. In some embodiments, the default item may be the first item of the specific group. It is understood that after the specific group is selected, the display unit displays all or some of the items in the specific group according to the size thereof. Additionally, items of another group adjacent to the specific group are displayed subsequent to the final item of the specific group. In some embodiments, a schematic diagram of the touch-sensitive mechanism may be also displayed in the display unit, and the contact position on the touch-sensitive mechanism can also be marked in the schematic diagram.

In step S240, it is determined whether contact remains with the surface of the touch-sensitive mechanism. If so (Yes in step S240), and no motion (drag) is detected (No in step S250), the procedure remains at step S240. If the contact remains (Yes in step S240) and motion is detected toward a direction (Yes in step S250), in step S260, the highlighted item is moved from the default item to another item according to the movement distance and direction, and re-selected. Thereafter, the procedure returns to step S240. If contact is terminated with the touch-sensitive mechanism (No in step S240), in step S270, the highlighted (selected) item is launched.

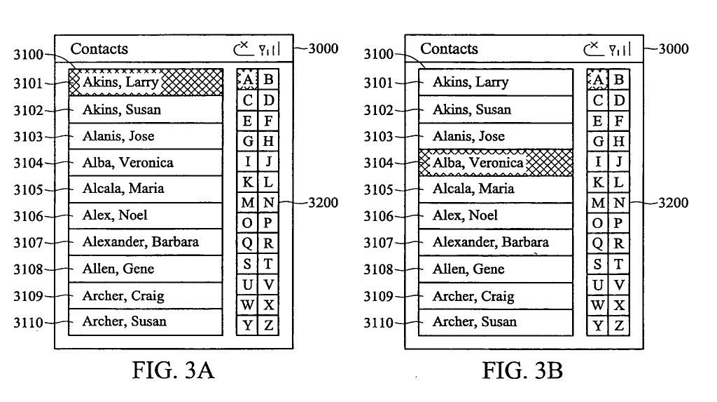

An example follows. In this example, the touch-sensitive mechanism is divided into 26 regions, respectively corresponding to characters “A” to “Z”, where “A” represents a record group beginning with “A”, “B” represents the record group beginning with “B”, and the like. It is understood that the division of the touch-sensitive mechanism is not limited thereto, and any kind of division can be applied to the application. If an address book is navigated, and an entry “Alba, Veronica” sought therein, contact at the region corresponding to the letter “A” on the touch-sensitive mechanism generates a menu displayed in the display unit, as shown in FIG. 3A. In FIG. 3A, the display unit 3000 comprises an item area 3100 and an area 3200. The item area 3100 displays a menu comprising items “Akins, Larry” 3101, “Akins, Susan” 3102, “Alanis, Jose” 3103, “Alba, Veronica” 3104, “Alcala, Maria” 3105, “Alex, Noel” 3106, “Alexander, Barbara” 3107, “Allen, Gene” 3108, “Archer, Craig” 3109, and “Archer, Susan” 3110, where item “Akins, Larry” 3101 is the default item and highlighted. Additionally, the area 3200 displays a schematic diagram of the touch-sensitive mechanism, and the contact position on the touch-sensitive mechanism is marked in the schematic diagram. In this example, since contact is made with the region corresponding to “A” on the touch-sensitive mechanism, the “A” region is marked and highlighted on the schematic diagram in the area 3200. It is noted that, in this example, contact with the touch-sensitive mechanism is to trigger the display of the menu in the display unit 3000. However, in some examples, contact with a specific region such as the top specific portion, any position, or any portion of the touch-sensitive mechanism for a predetermined interval can trigger display of the menu in the display unit 3000.

Contact movement up and down the touch-sensitive surface results in the highlighted item moving according to the direction of the movement. To locate the “Alba, Veronica” entry, contact moves down the touch-sensitive surface, such that the highlighted item stays at “Alba, Veronica” 3104, as shown in FIG. 3B. Termination of contact with the touch-sensitive mechanism allows item “Alba, Veronica” 3104 to be selected or launched.

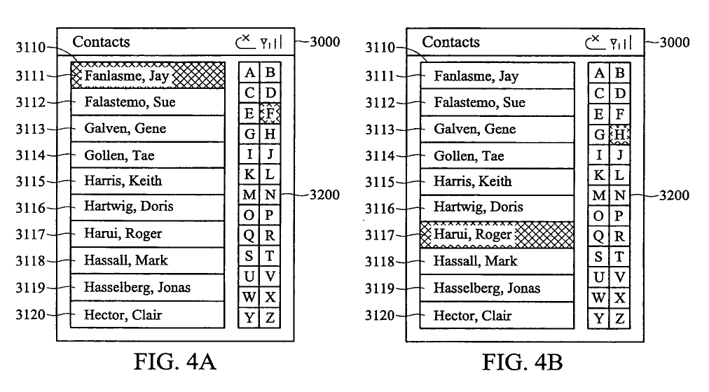

Since space on a touch-sensitive mechanism is limited, miscalculation of the contact position may occur. For example, if the “Harui, Roger” entry is sought, contact must be made with the region corresponding to “H” on the touch-sensitive mechanism. However, the “F” region on top of the “H” region may be inadvertently selected, as shown in FIG. 4A. In FIG. 4A, the item area 3100 displays a menu comprising items “Fanlasme, Jay” 3111, “Falastemo, Sue” 3112, “Galven, Gene” 3113, “Gollen, Tae” 3114, “Harris, Keith” 3115, “Hartwig, Doris” 3116, “Harui, Roger” 3117, “Hassall, Mark” 3118, “Hasselberg, Jonas” 3119, and “Hector, Clair” 3120, where default item “Fanlasme, Jay” 3111 is highlighted. Additionally, the “F” region is marked and highlighted on the schematic diagram in the area 3200. It is understood that, in this example, since only two items belong to the “F” group, the items of groups “G” and “H” are displayed subsequent to the items of group “F”. Despite selection of the wrong region “F”, scrolling through all items of the “G” group to arrive at item “Harui, Roger” 3117 of the “H” group by contact movement down the touch-sensitive mechanism can be accomplished, as shown in FIG. 4B. Termination of contact with the touch-sensitive mechanism allows item “Harui, Roger” 3117 to be selected or launched. It is noted that if the highlighted item belongs to the “H” group, the “H” region of the schematic diagram in the area 3200 is highlighted.

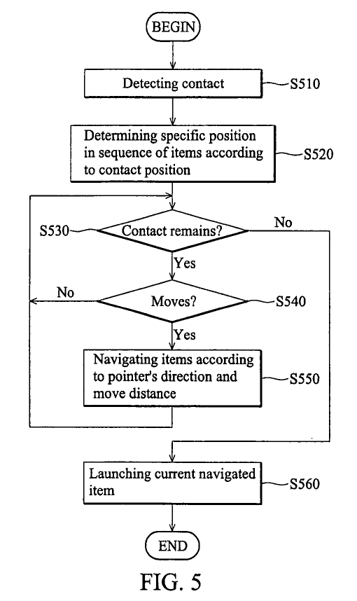

FIG. 5 is a flowchart of another embodiment of an item navigation and selection method. In this embodiment, a specific position in a sequence of items is determined, and item navigation begins from the specific position.

In step S510, contact of a pointer such as a finger or stylus on the touch-sensitive mechanism is detected. In step S520, a specific position in a sequence of items is determined according to a contact position on the touch-sensitive mechanism. In step S530, it is determined whether contact remains with the surface of the touch-sensitive mechanism. If the contact remains (Yes in step S530) and no motion is detected (No in step S540), the procedure remains at step S530. If the contact remains (Yes in step S530) and contact moves toward a direction (Yes in step S540), in step S550, the items are navigated from the specific position in the sequence according to the direction of contact movement. If contact is terminated with the touch-sensitive mechanism (No in step S530), in step S560, the current navigated item in the sequence is launched.

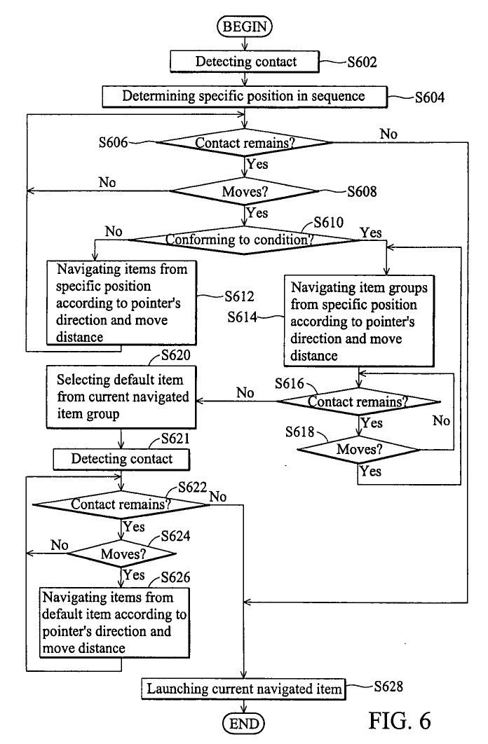

FIG. 6 is a flowchart of still another embodiment of an item navigation and selection method. In this embodiment, item navigation mode and group navigation mode are provided. Users can first navigate respective items in the item navigation mode. If the movement of the pointer conforms to a condition, the group navigation mode is activated, and respective groups are navigated. After a specific item group is determined, the item navigation mode is reactivated, and respective items are navigated.

In step S602, contact of a pointer such as a finger or stylus on the touch-sensitive mechanism is detected. In step S604, in response to the contact, a specific position in a sequence is determined. The sequence comprises a plurality of item groups, each comprising at least one item. The item may be any kind of data, such as email messages, address book entries, and others. The items may be grouped according to letter, numeral, or date. It is understood that the specific position in step S604 can be determined according to a contact position on the touch-sensitive mechanism, or by directly selecting a default position.

In step S606, it is determined whether contact remains with the surface of the touch-sensitive mechanism. If the contact remains (Yes in step S606) and no motion is detected (No in step S608), the procedure remains at step S606. If the contact remains (Yes in step S606) and the pointer moves toward a direction (Yes in step S608), in step S610, it is determined whether the movement of the pointer conforms to a condition. It is noted that the condition can be preset according to various requirements, for example, to determine whether the movement speed or distance of the pointer, or the contact time of the pointer on the touch-sensitive mechanism reaches a predetermined threshold. If not (No in step S610), in step S612, the items are navigated from the specific position in the sequence according to the movement direction and distance of the pointer (item navigation mode). If contact is terminated with the touch-sensitive mechanism (No in step S606), in step S628, the current navigated item in the sequence is launched.

If so (Yes in step S610), in step S614, the item groups are navigated from the specific position in the sequence according to the movement direction and distance of the pointer (group navigation mode). Thereafter, in step S616, it is determined whether contact remains with the surface of the touch-sensitive mechanism. If so (Yes in step S616) and no motion is detected (No in step S618), the procedure remains at step S616. If the contact remains (Yes in step S616) and the pointer moves toward a direction (Yes in step S618), the determination of step S614 follows. If contact is terminated with the touch-sensitive mechanism (No in step S616), in step S620, a default item in the current navigated item group is selected. In some embodiments, the default item may be the first item in the item group.

It is understood that, in some embodiments, if contact movement conforms to the condition (Yes in step S610), group navigation mode is activated. If the contact remains and no move, the item groups are automatically changed. For example, the item groups are displayed every predetermined interval in order for navigation in the group navigation mode. If contact is terminated with the touch-sensitive mechanism, the first item in the current navigated item group is selected.

In step S621, contact of the pointer on the touch-sensitive mechanism is detected again. In step S622, it is determined whether contact remains with the surface of the touch-sensitive mechanism. If the contact remains (Yes in step S622) and no motion is detected (No in step S624), the procedure remains at step S622. If the contact remains (Yes in step S622) and the pointer moves toward a direction (Yes in step S624), in step S626, the items are navigated from the default item in the item group according to the movement direction and distance of the pointer (item navigation mode). Thereafter, the procedure returns to step S622. If contact is terminated with the touch-sensitive mechanism (No in step S622), in step S628, the current navigated item is launched.

In the invention, scrolling navigation and item selection can be initiated in various positions on a list of items by contacting a specific zone on a touch-sensitive mechanism. Contact with the touch-sensitive mechanism allows scrolling, selection, and highlight of specific items.

Item navigation and selection methods, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the device thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the device becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An item navigation and selection method, comprising:
detecting contact on a touch-sensitive mechanism;
in response to the contact, determining a first group from a sequence of item groups according to a contact position on the touch-sensitive mechanism, and selecting a first item as a selected item from items in the first group;
determining whether the contact on the touch-sensitive mechanism remains; and
if the contact remains and moves toward a direction, re-selecting a second item as the selected item from the items according to the direction.

2. The method of claim 1, further comprising:
when the contact is detected,
in response to the contact, displaying part or all of the items in a display unit; and
highlighting the selected first item.

3. The method of claim 1, further comprising:
displaying a schematic diagram of the touch-sensitive mechanism in a display unit, where the schematic diagram comprises a plurality of regions corresponding to respective item groups; and
marking a contact position corresponding to the contact on the touch-sensitive mechanism in the schematic diagram.

4. The method of claim 1, wherein the contact is in a specific portion of the touch-sensitive mechanism, wherein the touch-sensitive mechanism comprises an elongated touch-sensitive surface, and the specific portion comprises one of two ends of the elongated touch-sensitive surface.

5. The method of claim 1, wherein the contact is in any portion of the touch-sensitive mechanism.

6. The method of claim 1, wherein the contact is in any portion of the touch-sensitive mechanism and contacts for a predetermined interval.

7. The method of claim 1, wherein the contact is detected by detecting signals corresponding to contact made with the touch-sensitive mechanism.

8. The method of claim 1, further comprising:
if the contact remains and moves toward the direction, and the second item is the final item in the first group, re-determining a second group from the item groups according to the direction; and
re-selecting a third item as the selected item from items in the second group.

9. The method of claim 1, wherein the items are grouped into item groups according to letter, numeral, or date.

10. An item navigation and selection method, comprising:
detecting contact on a touch-sensitive mechanism;
determining a specific position from a sequence of a plurality of items according to a contact position on the touch-sensitive mechanism;
determining whether the contact on the touch-sensitive mechanism remains;
and
if the contact remains and moves in a direction, the items are navigated from the specific position in the sequence according to the direction.

11. A machine-readable storage medium comprising a computer program, which, when executed, causes a portable device to perform an item navigation and selection method, the method comprising:
detecting a contact on a touch-sensitive mechanism;
in response to the contact, determining a first group from a sequence of item groups, and selecting a first item as a selected item from items in the first group;
determining whether the contact on the touch-sensitive mechanism remains; and
if the contact remains and moves toward a direction, re-selecting a second item as the selected item from the items according to the direction.

12. The storage medium of claim 11, wherein the method further comprises:
when the contact is detected,
in response to the contact, displaying part or all of the items in a display unit; and
highlighting the selected first item.

13. The storage medium of claim 11, wherein the method further comprises:
displaying a schematic diagram of the touch-sensitive mechanism in a display unit, where the schematic diagram comprises a plurality of regions corresponding to respective item groups; and
marking a contact position corresponding to the contact on the touch-sensitive mechanism in the schematic diagram.

14. The storage medium of claim 11, wherein the contact is in a specific portion of the touch-sensitive mechanism, wherein the touch-sensitive mechanism comprises an elongated touch-sensitive surface, and the specific portion comprises one of two ends of the elongated touch-sensitive surface.

15. The storage medium of claim 11, wherein the contact is in any portion of the touch-sensitive mechanism.

16. The storage medium of claim 11, wherein the contact is in any portion of the touch-sensitive mechanism for a predetermined interval.

17. The storage medium of claim 11, wherein the contact is detected by detecting signals corresponding to contact made with the touch-sensitive mechanism.

18. The storage medium of claim 11, wherein the method further comprises:
if the contact remains and moves toward the direction, and the second item is the final item in the first group, re-determining a second group from the item groups according to the direction; and
re-selecting a third item as the selected item from items in the second group.

19. The storage medium of claim 11, wherein the items are grouped into item groups according to letter, numeral, or date.

20. The storage medium of claim 11, wherein the portable device comprises a PDA, smart phone, global positioning device, or mobile phone.

21. A machine-readable storage medium comprising a computer program, which, when executed, causes a portable device to perform an item navigation and selection method, the method comprising:
detecting contact on a touch-sensitive mechanism;
determining a specific position from a sequence of a plurality of items according to a contact position on the touch-sensitive mechanism;
determining whether the contact on the touch-sensitive mechanism remains; and
if the contact remains and moves toward a direction, the items are navigated from the specific position in the sequence according to the direction.

22. An item navigation and selection method, comprising:
detecting a contact on a touch-sensitive mechanism;
in response to the contact, determining a specific position from a sequence of items, where the sequence comprises a plurality of item groups, each comprising at least one item;
determining whether the contact on the touch-sensitive mechanism remains;
if the contact remains and moves toward a first direction, the items are navigated from the specific position according to the first direction;
determining whether the movement conforms to a condition; and
if the movement conforms to the condition, the item groups are navigated according to the first direction.

23. The method of claim 22, wherein when the item groups are navigated according to the direction, further comprising:
if the contact does not remain, selecting a default item from a current navigated item group;
detecting contact on a touch-sensitive mechanism again; and
if the contact remains and moves toward a second direction, the items are navigated from the default item according to the second direction.

24. The method of claim 22 further comprising determining whether the movement conforms to the condition by determining whether a movement speed or distance, or a contact time on the touch-sensitive mechanism reaches a predetermined threshold.

25. The method of claim 22, wherein when the item groups are navigated, further comprising displaying the item groups every predetermined interval in order for navigation.

26. A machine-readable storage medium comprising a computer program, which, when executed, causes a portable device to perform an item navigation and selection method, the method comprising:
detecting contact on a touch-sensitive mechanism;
in response to the contact, determining a specific position from a sequence of items, where the sequence comprises a plurality of item groups, each comprising at least one item;
determining whether the contact on the touch-sensitive mechanism remains;
if the contact remains and moves toward a first direction, the items are navigated from the specific position according to the first direction;
determining whether the movement conforms to a condition; and
if the movement conforms to the condition, the item groups are navigated according to the first direction.
